(19) United States
(12) Patent Application Publication
(10) Pub. No.: US 2026/0093645 A1
(43) Pub. Date: Apr. 2, 2026

(54) APPARATUSES AND METHODS FOR MANAGING MEMORY ACCESS

(71) Applicant: Micron Technology, Inc., Boise, ID (US)

(72) Inventor: Leon Zlotnik, Camino, CA (US)

(21) Appl. No.: 19/330,052

(22) Filed: Sep. 16, 2025

Related U.S. Application Data
(60) Provisional application No. 63/701,171, filed on Sep. 30, 2024.

(51) Int. Cl. G06F 13/16

(52) U.S. Cl. CPC G06F 13/1689; G06F 13/1626; G06F 13/1663

(57) ABSTRACT

Various memory access management schemes are described. Access requests received from multiple processing units in a particular order can be responded to by either providing the instructions requested by the access requests or by providing alternative instructions (or any combination thereof) that cause the processing units to re-access at a later point. The alternative instructions can be provided when the timing requirements associated with the access requests are not expected to be met, ensuring a continuous flow of access requests, which may be disrupted if the timing requirements are eventually met.

### PRIORITY INFORMATION

This Application claims the benefits of U.S. Provisional Application Number 63/701,171, filed on September 30, 2024, the contents of which are incorporated herein by reference.

### TECHNICAL FIELD

Embodiments of the disclosure relate generally to electronic systems, and more specifically to apparatuses and methods for managing memory access.

### BACKGROUND

Various types of electronic devices such as logic circuits may store and process data. A logic circuit is an electronic circuit that processes digital signals or binary information, which can take on two possible values (usually represented as 0 and 1). The logic circuit can use logic gates to manipulate and transform the signals or binary information. Digital logic circuits can be used in a wide range of electronic devices including, for example, computers, calculators, digital clocks, and many other electronic devices that employ digital processing. Digital logic circuits can be designed to perform specific logical operations on digital inputs to generate digital outputs, and, in some instances, can be combined to form more complex circuits to perform more complex operations.

### BRIEF DESCRIPTION OF THE DRAWINGS

The present disclosure will be understood more fully from the detailed description given below and from the accompanying drawings of various embodiments of the disclosure.

FIG. 1 illustrates an example of a portion of a computing system for managing memory access in accordance with some embodiments of the present disclosure.

FIGS. 2A-2C illustrate a process of managing memory access in accordance with some embodiments of the present disclosure.

FIG. 3 is a flow diagram corresponding to a method for managing memory access in accordance with various embodiments of the present disclosure.

### DETAILED DESCRIPTION

Aspects of the present disclosure are directed to apparatuses and methods for managing memory access. Instruction memory is a specialized type of memory in computing systems designed to store the instructions that a processing unit (such as a CPU or microcontroller) needs to execute programs. The efficiency of this fetching process is crucial for overall system performance, as the speed and timing with which instructions are retrieved and executed directly impact the processing unit’s ability to perform operations without delays or interruptions. Instruction memory is typically optimized for quick access to ensure that the processing unit can retrieve and execute instructions in a timely manner, maintaining a smooth and efficient workflow within the system.

In multi-core processing systems, multiple processing units, or "cores," can be integrated within a single processor. Each core can independently execute instructions and run tasks, allowing the system to perform multiple operations simultaneously, thereby increasing overall processing power and efficiency. These systems are designed to handle more complex workloads, improve performance in multitasking environments, and enhance parallel processing capabilities, making them ideal for applications requiring significant computational power, such as gaming, data processing, and scientific simulations.

In some multi-core processing systems, the system is provided with a dedicated instruction memory that can be shared by multiple processing units of the system. This architecture allows each processing unit to access instructions independently, even when multiple processing units are executing the same code. However, this approach has several limitations. One significant issue is the lack of flow control to handle delayed memory responses. This deficiency can result in the entire processing unit being paused if the memory data is not provided promptly, leading to inefficiencies in processing speed and overall performance.

In some other multi-core processing system, a separate instruction memory is provided for each processing unit of the system. While this method may not compromise the performance and simplifies the implementation, it is highly inefficient in terms of both area and power consumption that can be occupied by the processing units. Each processing unit, even when running identical tasks, is coupled to its own memory, leading to a significant waste of resources, especially in systems where numerous processing units are deployed. For instance, in systems with up to 16 identical NAND Flash Controller (NFC) blocks, each equipped with its own embedded processing unit, the duplication of instruction memories represents a substantial overhead in silicon area and power usage.

In further alternative approaches, multiple processing units may share a single memory, which introduces the risk of collisions when multiple processing units attempt to access the memory simultaneously. Especially when the processing unit memory interface lacks flow control, this often necessitates gating the clock to the entire processing unit to manage delays in the instruction stream, which can severely compromise performance. For example, gating the clock can pause the execution of current instructions, which can be particularly detrimental if the delayed instruction is never used, such as in cases of branch misprediction or instruction flushes. Given that processing units typically employ instruction prefetching and may require more than one clock cycle per instruction on average, the performance impact of such delays can be significant.

Various embodiments of the present disclosure address these challenges by introducing a solution that effectively incorporates flow control into the memory interface, making it easily adaptable to various processing units, controllers, etc. More particularly, embodiments are specifically designed to manage collisions without necessitating a pause in operating the processing units.

As used herein, the term “collision” refers to an event in which two or more processing units or controllers concurrently attempt to access the same resource, such as memory or a communication channel, resulting in a potential conflict. Such collisions, if unmanaged, could disrupt system operations by causing delays, data corruption, or other unintended consequences. In various embodiments, when a collision occurs, the system does not stop the processing units but instead returns an alternative instruction, such as a JUMP instruction (alternatively referred to as “fake JUMP instruction”), ensuring a continuous flow of operations of the processing units. This provides a practical and efficient means of enhancing performance and optimizing the resource utilization of the computing system, especially in systems with multiple processing units operating concurrently.

Still, this fake JUMP instruction may cause a minor performance degradation, as it essentially introduces a NOP (No Operation)-like cycle into the processing units’ execution sequence. However, there are instances where the processing units may simply discard the fake JUMP instruction, resulting in no adverse impact on performance.

In one example, more complex processing units may often exhibit a higher clock-per-instruction ratio, in which each instruction may span several clock cycles due to the complexity of operations such as decoding, executing, and accessing memory. This is particularly true for instructions that involve multiple stages of processing, such as floating-point operations, memory accesses, or instructions that require interaction with multiple functional units within the processing units. Because these instructions naturally extend over multiple clock cycles, the pipeline of the processing units is often busy processing these instructions in parallel stages, which means that the inclusion of a fake JUMP instruction, which acts similarly to a NOP (No Operation), can be easily absorbed into the gaps between these stages. As a result, the fake JUMP instruction does not significantly disrupt the system’s operation or overall performance.

In another example, in which the delay caused by the fake JUMP is effectively masked by other instructions that are already consuming multiple clock cycles, the impact on performance can be minimal. The processing units can continue executing complex instructions without noticeable interruption, thus maintaining a steady throughput. Consequently, the overall performance of the system may remain largely unaffected by the inclusion of a fake JUMP instruction, as the natural latency and overlap of multi-cycle instructions provide ample opportunity to hide such delays.

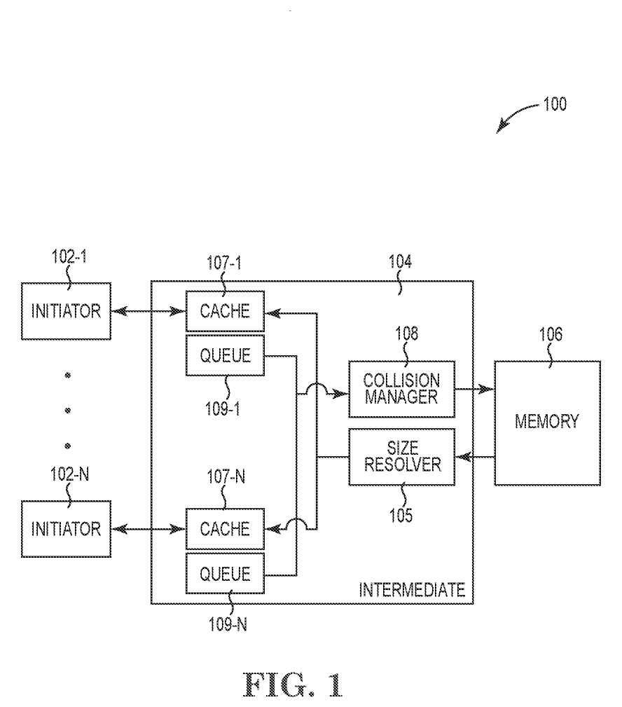

FIG. 1 illustrates an example of a portion of a computing system for managing memory access in accordance with some embodiments of the present disclosure. The computing system 100 can be a computing device such as a desktop computer, laptop computer, server, network server, mobile computing device, a vehicle (e.g., airplane, drone, train, automobile, or other conveyance), Internet of Things (IoT) enabled device, embedded computer (e.g., one included in a vehicle, industrial equipment, or a networked commercial device), system-on-chip (SoC), chipsets (e.g., a collection of integrated circuits), tiles, Field-Programmable Gate Arrays (FPGA) structures (e.g., segmented FPGA structures), or such computing device that includes memory and a processing device. As used herein, the term “mobile computing device” generally refers to a handheld computing device that has a slate or phablet form factor. In general, a slate form factor can include a display screen that is between approximately 3 inches and 5.2 inches (measured diagonally), while a phablet form factor can include a display screen that is between approximately 5.2 inches and 7 inches (measured diagonally). Examples of “mobile computing devices” are not so limited, however, and in some embodiments, a “mobile computing device” can refer to an IoT device, among other types of edge computing devices.

As illustrated in FIG. 1, the computing system 100 includes initiator components 102-1, …, 102-N. The initiator components 102 (alternatively referred to as initiators, hosts, processing units, etc.) are entities from which an access request are provided. For example, the initiator components 102 can generate and issue (e.g., provide) an access request to access (e.g., to write data to or read data from) locations within a memory 106. Although embodiments are not so limited, the initiator components 102 can be processing resources including various processing units, such as a central processor unit (CPU), direct memory access (DMA) processor, digital signal processor (DSP), etc.

In some embodiments, the initiator components 102 can each be a separate processor, which may be implemented as distinct intellectual property (IP) cores (e.g., separate blocks of data and/or logic within an application-specific integrated circuit or field-programmable gate array). Alternatively, the initiator components 102 could be multiple cores (e.g., CPUs) within a single IP core, such as in a multi-core processor design.

The computing system 100 includes a memory 106. In various embodiments, the memory 106 can be a tightly coupled memory (TCM), which refers to a memory that is located near to the initiators 102 and/or intermediate component 104 and has a constant access time (e.g., deterministic), as compared to cache memory which has a variable access time since there can be a cache “hit” or “miss.” A TCM is often used for critical routines and/or real time tasks for which constant access time may be necessary. In instances in which the memory 106 is a TCM, it can be implemented as DRAM or SRAM, for example. The memory 106 can store data, information, instructions, etc. that can be accessed by the initiator components 102.

Accessing memory 106 by initiator components 102 can include “fetching” instructions from the memory 106. For example, initiator components 102 can each be a processing unit (e.g., CPU) that can access the memory 106 to fetch instructions and execute them once received. Fetching instructions from the memory 106 can involve providing addresses (via an intermediate component 104) to the memory 106 from which the instructions are to be fetched.

The types of instructions that can be fetched from the memory 106 include, but are not limited to, data transfer instructions (such as load, store, move, push, and pop), arithmetic instructions (like add, subtract, multiply, divide, increment, and decrement), logical instructions (including AND, OR, XOR, NOT, and shift operations), control flow instructions (such as jump, conditional jump, call, return, and loop), comparison instructions (compare and test), bit manipulation instructions (set/clear bit and rotate), input/output instructions (in and out), special instructions (NOP and halt), floating-point instructions (for arithmetic operations on floating-point numbers and load/store operations), and vector/multimedia instructions (SIMD and multimedia-specific operations).

As illustrated in FIG. 1, the computing system 100 includes an intermediate component 104 (alternatively referred to as a controller 104), through which memory 106 can be accessed by the initiator components 102. The intermediate component 104 can include hardware circuitry to perform the operations described herein. For example, the intermediate component 104 can include special purpose circuitry in the form of an ASIC, FPGA, state machine, and/or other logic circuitry.

As illustrated in FIG. 1, the memory 106 can be “shared” by multiple initiator components 102. In other words, data stored in the same memory 106 can be accessed (e.g., retrieved and utilized) by multiple initiator components 102. In a particular example, where the memory 106 stores instructions, these instructions can be fetched to and executed at the multiple initiator components 102.

The intermediate component 104 can include and/or provide caches 107-1, …, 107-N (collectively referred to as caches 107) and queues 109-1, …, 109-N (collectively referred to as queues 109) for the respective initiator components 102-1, …, 102-N. The caches 107 can temporarily store data, such as the most recently and/or frequently accessed data retrieved from the memory 106, for the corresponding initiator components 102. The queues 109 can temporarily store access requests provided by and received from the respective initiator components 102. In an example where the memory 106 stores instructions that can be fetched by the initiator components 102, the caches 107 can store instructions fetched from the memory 106, while the queues 109 can store access requests (which may take the form of addresses of the memory 106 to be accessed) provided by and received from the initiator components 102.

For example, the intermediate component 104 includes a collision manager 108, which can operate to meet the requirements associated with access requests received from the initiator components 102. In a non-limiting example, the collision manager 108 can arrange access to the memory 106 and organize data accessed (e.g., retrieved) from the memory 106 so that the data can be sent to the caches 107 in the same order they were received at the intermediate component 104 (e.g., queues 109). Additionally, the intermediate component 104 includes a size resolver 105 (alternatively referred to as an “instruction length resolver”), which can identify the size of the data (e.g., the length of an instruction) retrieved from the memory 106. The collision manager 108 and size resolver 105 can each include hardware circuitry to perform the operations described herein. For example, the collision manager 108 and size resolver 105 can each include special purpose circuitry in the form of an ASIC, FPGA, state machine, and/or other logic circuitry.

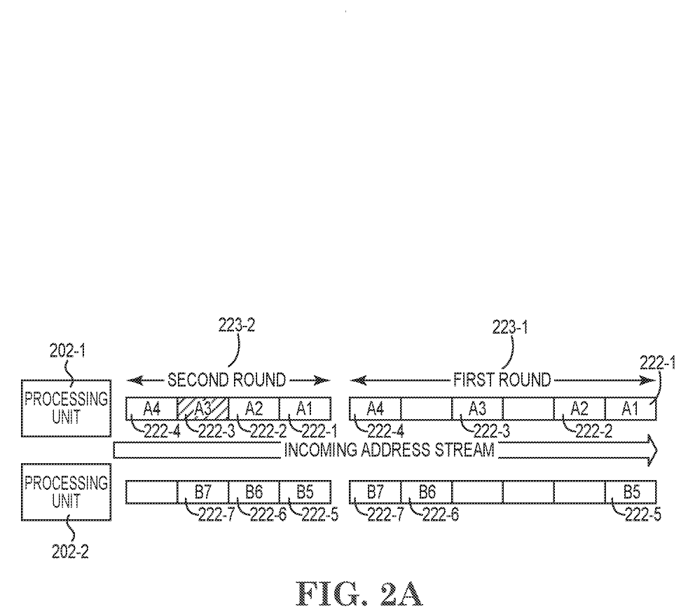

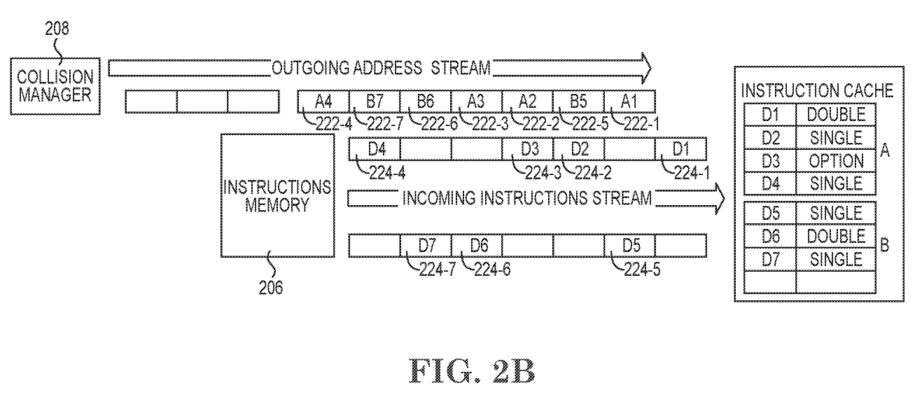

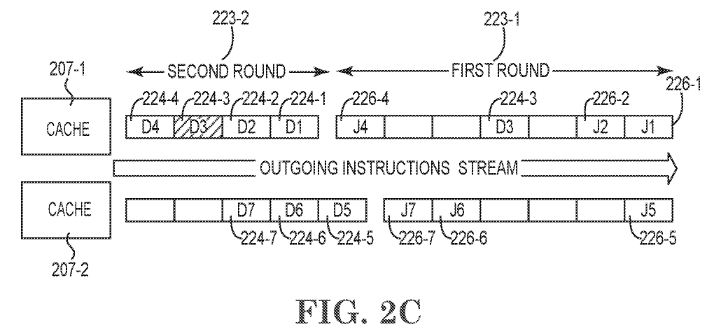

Utilizing various circuits (e.g., those mentioned above), the intermediate component 104 can manage data retrieval (e.g., fetching instructions) from the memory 106 to provide conflict-free access for multiple initiator components 102. More specifically, the intermediate component 104 can manage access requests from the initiator components 102 in a way that ensures various requirements (e.g., timing requirements) associated with the access requests are still met, even if data retrievals are delayed due to the memory 106 being accessed by multiple initiator components 102. Further details associated with the management of access requests are illustrated in FIGS. 2A-2C.

FIGS. 2A-2C illustrate a process of managing memory access in accordance with some embodiments of the present disclosure. Processing units 202-1, 202-2 (collectively referred to as processing units 202), instruction caches 207-1, 207-2 (collectively referred to as instruction caches 207), a collision manager 208, and a memory 206 shown in FIGS. 2A-2C can be respectively analogous to the initiator components 102, caches 107, collision manager 108, and memory 106 illustrated in FIG. 1. Although two processing units 202-1, 202-2 are illustrated in FIGS. 2A-2C, embodiments are not limited to a particular quantity of processing units (e.g., processing units 102, 202) whose access requests can be managed in fetching instruction from the memory 106, 206.

As illustrated in FIG. 2A, access requests are provided in forms of addresses 222-1, 222-2, 222-3, and 222-4, such as “A1”, “A2”, “A3”, and “A4”, from the processing unit 202-1 and addresses 222-5, 222-6, and 222-7, such as “B5”, “B6”, and “B7”, from the processing unit 202-2. The addresses “A1”, …, “A4” and “B5”, …, “B7” can correspond to locations in the memory 206 where instructions to be fetched are respectively stored. More particularly, (e.g., during a first round 223-1) addresses can be provided to the intermediate component (e.g., the intermediate component 104) in an order of “A1”, “A2”, “A3”, and “A4” from the processing unit 202-1, and in an order of “B5”, “B6”, and “B7” from the processing unit 202-2.

Each “slot” (in which a respective one of addresses 222-1, …, 222-7, instructions 224-1, …, 224-7, and/or instructions 226-1, 226-2, 226-4, 226-5, 226-6, 226-7 is located as illustrated in FIGS. 2B-2C) can represent a unit of clock cycles (e.g., one or more clock cycles). For example, from the processing unit 202-1 and to the intermediate component 104, the address “A1” is provided during a first unit of clock cycles; the address “A2” is provided during a second unit of clock cycles; the address “A3” is provided during a fourth unit of clock cycles (following a third unit of clock cycles, which is “empty”); and the address “A4” is provided during a sixth unit of clock cycles (following a fifth unit of clock cycles, which is “empty”). Similarly, from the processing unit 202-2 and to the intermediate component 104, the address “B5” is provided during a first unit of clock cycles; the address “B6” is provided during a fifth unit of clock cycles (following second, third, and fourth units of clock cycles, which are “empty”); and the address “B7” is provided during a sixth unit of clock cycle. Although embodiments are not so limited, the clock cycles on which the processing units 202-1 and 202-2 operate may be the same.

These addresses 222 provided from the processing units 202-1, 202-2 are received at a collision manager 208 (e.g., of the intermediate component 104 illustrated in FIG. 1). As illustrated in FIG. 2B, the collision manager 208 can manage over the conflicts among those timings at which the addresses are received from different processing unit 202 substantially simultaneously and provides these addresses to the memory 206 generally in an order in which they (addresses 222) were received at the intermediate component 104. In a non-limiting example illustrated in FIG. 2B, the collision manager 208 can prioritize the address “A1” over the address “B5” (that was received substantially simultaneously with the address “A1”) and prioritize the address “B7” over the address “A4” (that was received substantially simultaneously with the address “B7”); therefore, the addresses 222 are provided to the memory 206 in the order of “A1” (e.g., in a first position of the order), “B5” (e.g., in a second position of the order), “A2” (e.g., in a third position of the order), “A3” (e.g., in a fourth position of the order), “B6” (e.g., in a fifth position of the order), “B7” (e.g., in a sixth position of the order), and “A4” (e.g., in a seventh position of the order).

The addresses 222 provided to the memory 206 can cause instructions to be fetched from the addresses 222 of the memory 206 to the intermediate component 104. As illustrated in FIG. 2B, instructions 224-1, …, 224-7, such as “D1”, …., “D7” (respectively corresponding to the addresses “A1”, “A2”, A3”, A4”, “B5”, “B6”, and “B7”), are fetched from the memory 206 (and to the intermediate component 104). In a non-limiting example illustrated in FIGS. 2A-2C, the instructions 224-1, …, 224-7 are fetched from locations corresponding to the addresses 222-1, …, 222-7, respectively, of the memory 206. Although embodiments are not limited to a particular order in which the instructions are fetched from the memory 206, the instructions 224 are fetched in an order of “D1”, “D5”, “D2”, “D3”, “D6”, “D7”, and “D4”.

Instructions stored in and fetched from the memory 206 can be of various lengths, such as a single length or multi-length (or alternatively referred to as “variable-length), among others. For example, as illustrated in FIG. 2B, instructions “D2”, “D4”, “D5”, and “D7” are indicated as having single-length (“SINGLE”), instructions “D1” and “D6” are indicated as having a double-length (“DOUBLE”), and an instruction “D3” is indicated as being a “OPTION” as shown in FIG. 2B.

As used herein, each single-length instruction can have a fixed size, such as one word in the architecture (e.g., 32 bits or 4 bytes, though other sizes are possible). Additionally, multi-length instructions can consist of two or more of these single-length units (e.g., the size of more than one word), allowing for the encoding of more complex operations. More particularly, instructions with double length can be twice the size of single-length instructions.

In a non-limiting example illustrated in FIGS. 2A-2C, “D1” indicated as “double” and “D2” indicated as “single” can be part of the same instructions with “D1” being a first portion (alternatively referred to as a “head”) of the instruction and “D2” being a second portion (alternatively referred to as a “tail”) of the instruction. Similarly, in a non-limiting example illustrated in FIGS. 2A-2C, “D6” indicated as “double” and “D7” indicated as “single” can be part of the same instructions with “D6” being a first portion (alternatively referred to as a “head”) of the instruction and “D7” being a second portion (alternatively referred to as a “tail”) of the instruction.

The instructions 224 fetched from the memory 206 can be (e.g., temporarily) stored in instruction caches, such as instruction caches 207-1, 207-2 (e.g., that respectively correspond to the processing units 202-1, 202-2). Access requests provided (e.g., in forms of addresses, “A1”, …, “A4” and “B5”, …, “B7”) from the processing units 202-1, 202-2 can be responded in an order, in which they were received at the intermediate component 104. Additionally, responding to access requests (e.g., addresses 222) can be accomplished according to timing requirements set by the processing units 202-1, 202-2.

In a non-limiting example, the timing requirements that can be set by each processing unit 202 can include requiring an instruction (e.g., corresponding to each address provided from the processing unit 202) to be provided within a particular time period (e.g., clock cycles). While the intermediate component 104 can provide an instruction (e.g., instruction 224) fetched from an address (e.g., an address 222) to the processing unit 202 if doing so can still meet the timing requirements, the intermediate component 104 may instead provide an alternative instruction (e.g., instruction 226) to the processing unit 202 to ensure that the timing requirements are met and to maintain the flow of the processing unit’s operations. For example, the instruction caches 207 can either provide respective instructions (e.g., “D1”, …, “D7”) if they are available at the instruction caches 207 when the respective instructions are required to be provided to meet the timing requirements or provide alternative instructions (e.g., JUMP instructions) if they are not available (or expected to be unavailable) when the respective instructions are required to be provided to meet the timing requirements.

In a non-limiting example illustrated in FIG. 2C, a JUMP instruction 226-1 (“J1”) is returned to the processing unit 202-1 in replacement of the instruction 224-1 (e.g., “D1”), due to the instruction 224-1 being double-length and another portion of the double-length instruction (e.g., “D2”) not yet being available. Similarly, a JUMP instruction 226-2 (“J2”) is returned to the processing unit 202-1 in replacement of the instruction 224-2 (e.g., “D2”), due to the instruction 224-1 not being returned previously.

Continuing with the non-limiting example, the instruction 224-3 (e.g., “D3”) can be returned to the processing unit 202-1, due to the instruction 224-3 received and available at the instruction cache 207-1 in time to meet the timing requirement of the processing unit 202-2. In some embodiments, it may be redundant to return the instruction 224-3 because it could be disregarded following the issuance of two JUMP instructions 226-1, 226-2, depending on prefetch architecture of the processing unit 202-1. Accordingly, the intermediate component 104 may intentionally choose to provide another JUMP instruction (in lieu of “D3”) to the processing unit 202-2 during the first round 223-1 (along with “J1” and “J2”), despite that the instruction 224-3 was available in the instruction cache 207-1. In this scenario, “D3” can be provided to the processing unit 202-1 along with other instructions, “D1”, “D2”, “D3”, and “D4”, during the “second” round 223-2. On the other hand, if the instruction 224-3 has already been sent to the processing unit 202-1 during the “first” round 223-1, the instruction cache 207-1 may optionally choose to store or discard it based on the relevance of the instruction following the issuance of the JUMP instructions.

Further, a JUMP instruction “J4” is returned to the processing unit 202-1, due to the instruction “D4 not yet being available (e.g., in the instruction cache 207-1) in time to meet the timing requirement of the processing unit 202-1. Further, a JUMP instruction “J5” is returned to the processing unit 202-2, due to the instruction “D5” not yet being available (e.g., in the instruction cache 207-2) in time to meet the timing requirement of the processing unit 202-2.

Further, a JUMP instruction “J6” is returned to the processing unit 202-2 in response to the access request “B6” from the processing unit 202-2, due to the instruction “D6” being double-length and another portion of the double-length instruction (“D7”) not yet being available. Similarly, a JUMP instruction “J7” is returned to the processing unit 202-2 in response to the access request “B7” from the processing unit 202-2, due to the instruction “D6” not having been returned previously.

Each JUMP instruction, when executed by the respective processing unit 202, can cause the respective processing unit 202 to “jump” to (e.g., access) an address of the memory 206 specified by the JUMP instruction. More particularly, jump instructions 226-1, 226-2, 226-4, 226-5, 226-6, 226-7 can respectively cause the processing units 202-1, 202-2 to “jump” and issue access requests corresponding to (e.g., in forms of) “A1”, “A2”, “A4”, “B5”, “B6”, and “B7”, respectively, to the intermediate component 104 during a second round 223-2 as illustrated in FIG. 2A. Although embodiments are not so limited, JUMP instructions (e.g., JUMP instructions 226) can be generated at respective caches (e.g., instruction caches 207-1, 207-2).

Subsequent to the “first” round 223-1, instruction caches 207-1, 207-2 can respond to access requests corresponding to (in forms of) “A1”, “A2”, “A4”, “B5”, “B6”, and “B7” (that were triggered as a result of providing “J1”, “J2”, “J4”, “J5”, “J6”, and “J7”) without issuing further jump instructions if instructions 224-1, 224-2, 224-4, 224-5, 224-6, and 224-7 are already available at the instruction caches 207-1, 207-2. For example, as illustrated in FIG. 2C, instructions “D1”, “D2”, and “D4” that were triggered as a result of providing “J1”, “J2”, and “J4” can be provided to the processing unit 202-1, while instructions “D5”, “D6”, and “D7” that were triggered as a result of providing “J5”, “J6”, and “J7” can be provided to the processing unit 202-2. In some embodiments, the instruction “D3” can be optionally provided to the processing unit 202-1 along with instructions “D1”, “D2”, and “D4”.

Embodiments are not limited to a particular number of “rounds” (rounds 223-1, 223-2) during which access requests (corresponding to “A1”, “A2”, “A3”, “A4”, “B5”, “B6”, and “B7”) initially issued from the processing units 202-1, 202-2 are executed. For example, the execution of those access requests (corresponding to “A1”, “A2”, “A3”, “A4”, “B5”, “B6”, and “B7”) may take more than two rounds 223-1, 223-2, especially when there are more processing units (e.g., more than two processing units 202-1, 202-2) trying to access the memory 106. On the other hand, the execution of those access requests (corresponding to “A1”, “A2”, “A3”, “A4”, “B5”, “B6”, and “B7”) may be complete in a single round without issuing any fake JUMP instructions.

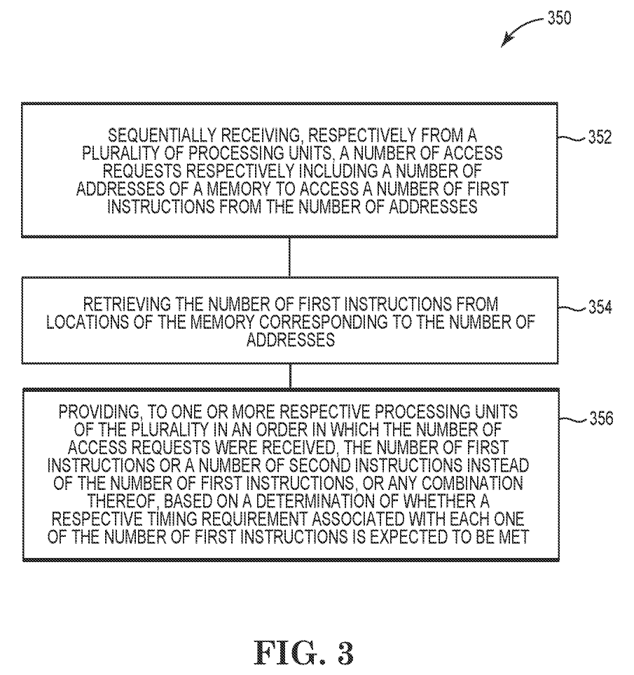

FIG. 3 is a flow diagram corresponding to a method 350 for managing memory access in accordance with various embodiments of the present disclosure. The method 350 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 350 is performed by the intermediate component 104 (alternatively referred to as “controller”) of FIGS. 1, 2A, 2B, 2C. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At 352, a number of access requests respectively including a number of addresses (e.g., addresses 222-1, …, 222-7 shown in FIGS. 2A-2C) of a memory (e.g., memory 106, 206 shown in FIGS. 1, 2A-2C) can be sequentially received from a plurality of processing units (e.g., processing units 102, 202-1, 202-2 shown in FIGS. 1, 2A-2C) to access a number of first instructions (e.g., instructions 224-1, …., 224-7 shown in FIGS. 2A-2C) from the number of addresses. At 354, the number of first instructions 224 can be retrieved (e.g., fetched) from locations of the memory 106, 206 corresponding to the number of addresses 222.

At 356, the number of first instructions 224 or a number of second instructions (e.g., JUMP instructions 226-1, 226-2, 226-4, 226-5, 226-6. and 226-7 shown in FIGS. 2A-2C) instead of the number of first instructions 224, or any combination thereof, can be provided to one or more respective processing units 102, 202 of the plurality (e.g., in an order in which the number of access requests were received) based on a determination of whether a respective timing requirement associated with each one of the number of first instructions 224 is expected to be met. Each second instruction 226, when executed by the respective processing unit 102, 202, causes the respective processing unit 102, 202 to access a respective address of the number of addresses 222. A respective first instruction 224 can be provided to the respective processing units 102, 202 responsive to determining that the timing requirement associated with the respective first instruction 224 is expected to be met.

Alternatively, a respective second instruction 226 can be provided to the respective processing units 202 in replacement of a respective first instruction 224 responsive to determining that the timing requirement associated with the respective first instruction 224 is not expected to be met. The respective second instruction 226 can be generated at the intermediate component 104 (e.g., caches 107, 207 shown in FIGS. 2A-2C) instead of retrieving from the memory 106, 206.

In one example, the respective second instruction 226 can be provided to the respective processing units 102, 202 responsive to determining that the respective first instruction 224 is not available when the respective first instruction 224 is required to be sent to meet the timing requirement associated with the respective first instruction 224. In another example, the respective second instruction 226 can be provided to the respective processing units 102, 202 responsive to determining that at least one of a plurality of portions (e.g., instructions 224-2, 224-7 shown in FIGS. 2A-2C) of the first instruction 224 is not available when the respective first instruction 224 is required to be sent to meet the timing requirement associated with the respective first instruction 224. Subsequent to providing the number of first instructions 224 or the number of second instructions 226, or any combination thereof, the respective first instruction 224 (for which the respective second instruction was previously provided as a replacement) can be provided to the respective processing units 102, 202 responsive to determining that the timing requirement associated with the respective first instruction 224 is now expected to be met.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method, comprising:
sequentially receiving, respectively from a plurality of processing units, a number of access requests respectively including a number of addresses of a memory to access a number of first instructions from the number of addresses;
retrieving the number of first instructions from locations of the memory corresponding to the number of addresses; and
providing, to one or more respective processing units of the plurality in an order in which the number of access requests were received, the number of first instructions or a number of second instructions instead of the number of first instructions, or any combination thereof, based on a determination of whether a respective timing requirement associated with each one of the number of first instructions is expected to be met;
wherein each second instruction, when executed by the respective processing unit, causes the respective processing unit to access a respective address of the number of addresses.

2. The method of claim 1, further comprising:
providing, to the respective processing units, a respective first instruction responsive to determining that the timing requirement associated with the respective first instruction is expected to be met.

3. The method of claim 1, further comprising:
providing, to the respective processing units, a respective second instruction in replacement of a respective first instruction responsive to determining that the timing requirement associated with the respective first instruction is not expected to be met.

4. The method of claim 3, further comprising:
providing, to the respective processing units, the respective second instruction responsive to determining that the respective first instruction is not available when the respective first instruction is required to be sent to meet the timing requirement associated with the respective first instruction.

5. The method of claim 3, further comprising:
providing, to the respective processing units, the respective second instruction responsive to determining that at least one of a plurality of portions of the first instruction is not available when the respective first instruction is required to be sent to meet the timing requirement associated with the respective first instruction.

6. The method of claim 3, further comprising:
generating, instead of retrieving from the memory and to provide to the respective processing units, the respective second instruction responsive to determining that the timing requirement associated with the respective first instruction is not expected to be met.

7. The method of claim 3, further comprising, subsequent to providing the number of first instructions or the number of second instructions, or any combination thereof:
providing, to the respective processing units, the respective first instruction for which the respective second instruction was previously provided as a replacement, responsive to determining that the timing requirement associated with the respective first instruction is now expected to be met.

8. An apparatus, comprising:
a controller, the controller comprising a plurality of caches;
wherein the controller is further configured to:
receive, respectively from a plurality of processing units and in a particular order, a number of addresses corresponding to respective locations of a memory shared by the plurality of processing units;
fetch a number of first instructions from the respective locations of the memory; and
provide, at each position of the particular order and to one or more respective processing units, a respective first instruction of the number of first instructions, or a respective second instruction of a number of second instructions based on a determination of whether a timing requirement of each processing unit is expected to be met.

9. The apparatus of claim 8, wherein:
the controller is configured to provide the respective second instruction in replacement of the respective first instruction; and
the respective second instruction, when executed by the respective processing unit, causes the respective processing unit to subsequently issue, to the controller, a respective address of the number of addresses corresponding to the respective first instruction.

10. The apparatus of claim 9, wherein the controller is configured to:
provide the respective first instruction in response to a determination that the respective first instruction is available at a respective cache of the plurality of caches when the respective first instruction is required to be sent to meet the timing requirement associated with the respective first instruction.

11. The apparatus of claim 9, wherein the controller is configured to:
provide the respective second instruction in replacement of the respective first instruction in response to a determination that the respective first instruction is not available at a respective cache of the plurality of caches when the respective first instruction is required to be sent to meet the timing requirement associated with the respective first instruction.

12. The apparatus of claim 9, wherein the controller is configured to:
provide, despite the first instruction being available in a respective cache of the plurality of caches, the respective second instruction in replacement of the respective first instruction in response to a determination that a respective second instruction was provided at a previous position of the particular order.

13. A system, comprising:
a plurality of processing units;
a memory shared by the plurality of processing units and configured to store instructions; and
a controller configured to:
sequentially receive a number of addresses respectively from the plurality of processing units, each address corresponding to a respective instruction of a number of instructions;
fetch the number of instructions from the memory;
to respond to each processing unit of the plurality in an order in which the number of addresses were received at the controller from the plurality of processing units:
provide, to a respective processing unit, a respective instruction of the number of instructions in response to a determination that a timing requirement associated with provision of the respective instruction is expected to be met; and
provide, to the respective processing unit, a respective alternative instruction in replacement of the respective instruction in response to a determination that a timing requirement associated with the respective instruction is not expected to be met, wherein the respective alternative instruction, when executed by the respective processing unit, causes the respective processing unit to access an address corresponding to the respective instruction.

14. The system of claim 13, wherein the controller is configured to:
sequentially receive a first address and a second address of the number of addresses; and
fetch, in response to receipt of the first address and the second address, a first instruction and a second instruction of the number of instructions respectively corresponding to the first address and the second address.

15. The system of claim 14, wherein the controller is configured to:
provide a first alternative instruction in replacement of the first instruction in response to a determination that the timing requirement associated with the first instruction is not expected to be met.

16. The system of claim 15, wherein the first alternative instruction is provided in replacement of the first instruction in response to a determination that:
the first instruction is a portion of a particular instruction; and
at least a remaining portion of the particular instruction is not available to be provided to the respective processing unit when the first instruction is required to be provided to the respective processing unit to meet the timing requirement.

17. The system of claim 15, wherein the controller is configured to:
provide a second alternative instruction in replacement of the second instruction in response to a determination that the first instruction was not previously provided to the respective processing unit.

18. The system of claim 17, wherein:
the first alternative instruction, when executed by the respective processing unit, causes the respective processing unit to access a location of the memory corresponding to the first address; and
the second alternative instruction, when executed by the respective processing unit, causes the respective processing unit to access a location of the memory corresponding to the second address.

19. The system of claim 17, wherein the first instruction, the second instruction, or both correspond to a JUMP instruction.

20. The system of claim 17, wherein the memory is a tightly coupled memory (TCM).
